(19) United States
(12) Patent Application Publication
(10) Pub. No.: US 2018/0097225 A1
(43) Pub. Date: Apr. 5, 2018

(54) LITHIUM-ION SECONDARY BATTERY AND CATHODE MATERIAL FOR LITHIUM-ION SECONDARY BATTERY

(71) Applicant: SUMITOMO OSAKA CEMENT CO., LTD., Tokyo (JP)

(72) Inventors: Ryuuta YAMAYA, Narashino-shi (JP); Susumu MURATA, Inzai-shi (JP); Satoru OSHITARI, Funabashi-shi (JP); Hirofumi YASUMIISHI, Yachiyo-shi (JP)

(21) Appl. No.: 15/461,146

(22) Filed: Mar. 16, 2017

(30) Foreign Application Priority Data
Sep. 30, 2016 (JP) 2016-193365

(51) Int. Cl. H01M 4/36; H01M 10/0525; H01M 4/66; H01M 4/58; H01M 4/62

(52) U.S. Cl. CPC H01M 4/366; H01M 10/0525; H01M 2004/028; H01M 4/5825; H01M 4/625; H01M 4/661

(57) ABSTRACT

A lithium-ion secondary battery including a cathode, an anode, and an electrolyte, in which the cathode includes an aluminum current collector and a cathode mixture layer formed on the aluminum current collector, and an interface resistance value between the cathode mixture layer and the aluminum current collector is 1 Ω·cm² or less.

### CROSS-REFERENCE TO RELATED APPLICATIONS

This application claims the benefit of Japanese Patent Application No. 2016-193365 filed Sep. 30, 2016, the disclosure of which is herein incorporated by reference in its entirety.

### BACKGROUND OF THE INVENTION

### Field of the Invention

The present invention relates to a lithium-ion secondary battery and a cathode material for a lithium-ion secondary battery.

### Description of Related Art

Lithium-ion secondary batteries have a higher energy density and a higher power density than lead batteries and nickel-hydrogen batteries and are used in a variety of applications such as small-size electronic devices such as smartphones, domestic backup power supply, and electric tools. In addition, attempts are made to put high-capacity lithium-ion secondary batteries into practical use for recyclable energy storage such as photovoltaic power generation and wind power generation.

Lithium-ion secondary batteries include a cathode, an anode, and a separator. As electrode materials that constitute cathodes, lithium-containing metal oxides having properties capable of reversibly intercalating and deintercalating lithium ions such as lithium cobalt oxide (LiCoO₂), lithium manganese oxide (LiMn₂O₄), and lithium iron phosphate (LiFePO₄) are used, and studies are made in order for improvement from the viewpoint of an increase in the capacity of batteries, the extension of service lives, improvement of safety, and cost reduction.

Lithium iron phosphate (LiFePO₄) as the electrode material contains iron which is an abundant and inexpensive resource and is thus a material the cost of which can be easily reduced. Lithium iron phosphate does not emit oxygen at high temperatures due to the strong covalent bond between phosphorus and oxygen and thus has outstanding safety, which provides lithium iron phosphate with excellent characteristics that oxide-based cathode materials represented by lithium cobalt oxide do not have.

On the other hand, lithium iron phosphate has low Li ion diffusivity and low electron conductivity and thus has worse input and output characteristics than oxide-based cathode materials. This characteristic difference becomes more significant as the operation temperature of batteries becomes lower, and thus lithium iron phosphate has been considered to be inappropriate for in-vehicle applications such as hybrid vehicles for which high input and output characteristics are required at low-temperature regions.

LiMPO₄ (M represents a metal element) having an olivine structure which is represented by lithium iron phosphate has low Li ion diffusivity and low electron conductivity, and thus it is possible to improve the charge and discharge characteristics by miniaturizing LiMPO₄ primary particles and coating the surfaces of the respective primary particles with a conductive carbonaceous film.

On the other hand, since the miniaturized LiMPO₄ has a large specific surface area, an increase in the viscosity of an electrode mixture slurry or a large amount of a binder is required, and thus it is usual to improve the properties of the electrode mixture slurry by turning the primary particles coated with a carbonaceous film into secondary particles by means of granulation.

For example, as an electrode material, Japanese Patent No. 5343347 discloses a cathode active material for a lithium secondary battery in which primary particle crystals agglomerate together and thus form spherical secondary particles and which includes parent particles which have pores on the surfaces and the inside of the secondary particles and are made of a lithium nickel manganese-based complex oxide and conductive fine powder loaded into part of the pores of the parent particles. In addition, Japanese Laid-open Patent Publication No. 2015-018678 discloses a cathode active material for a lithium secondary battery including particles having pores in secondary particles.

### SUMMARY OF THE INVENTION

Electrode mixture layers are formed by applying, drying, and calendering an electrode slurry obtained by mixing an electrode material, a conductive auxiliary agent, a binder, or the like on an aluminum current collector. However, in the electrode materials described in Japanese Patent No. 5343347 and Japanese Laid-open Patent Publication No. 2015-018678, since pores are present in the secondary particles (hollow secondary particles), the electrode structure becomes uneven, and the Li ion conductivity and the electron conductivity decrease. In addition, excessive calendering becomes necessary in order to make the electron structure uniform, and battery characteristics are also degraded due to the peeling of conductive carbonaceous films caused by the collapse of the secondary particles or the dropping of the electrode mixture layer from the aluminum current collector.

As described above, improvement of the charge and discharge characteristics essentially requires not only electrode materials but also improvement of the conductivity of electrode mixture layers constituting electrodes.

The present invention has been made in consideration of the above-described circumstances, and an object of the present invention is to provide a lithium-ion secondary battery having improved charge and discharge characteristics and a cathode material for a lithium-ion secondary battery capable of decreasing the volume resistance value of electrode mixture layers and the interface resistance value between the electrode mixture layers and aluminum current collectors.

The present inventors and the like carried out intensive studies in order to achieve the above-described object and found that the object can be achieved by means of the following inventions.

<1> A lithium-ion secondary battery including a cathode, an anode, and an electrolyte, in which the cathode includes an aluminum current collector and a cathode mixture layer formed on the aluminum current collector, and an interface resistance value between the cathode mixture layer and the aluminum current collector is 1 Ω·cm² or less.

<2> The lithium-ion secondary battery according to [1], in which a volume resistance value of the cathode mixture layer is 5 Ω·cm or less.

<3> The lithium-ion secondary battery according to <1> or <2>, in which an electrode density of the cathode mixture layer after calendering is 1.4 g/cm³ or more.

<4> The lithium-ion secondary battery according to any one of <1>to <3>, in which the cathode mixture layer includes a cathode material made of agglomerated particles formed by agglomeration of a plurality of primary particles of a cathode active material represented by General Formula (1) below which are coated with a carbonaceous film,

LiₓA_{y}D_{z}PO₄ (1)

(here, A represents at least one element selected from the group consisting of Co, Mn, Ni, Fe, Cu, and Cr, D represents at least one element selected from the group consisting of Mg, Ca, Sr, Ba, Ti, Zn, B, Al, Ga, In, Si, Ge, Sc, and Y, 0.9<x<1.1, 0<y≦1, 0≦z<1, and 0.9<y+z<1.1).

<5> A cathode material fora lithium-ion secondary battery made of agglomerated particles formed by agglomeration of a plurality of primary particles of a cathode active material represented by General Formula (1) below which are coated with a carbonaceous film, in which, in a case in which a cathode mixture layer including the cathode material, a conductive auxiliary agent, and a binding agent in a weight ratio (the cathode material/the conductive auxiliary agent/the binding agent) of 90:5:5 is calendered on a 30 μm-thick aluminum current collector at a total applied pressure of 5 t/250 mm, an interface resistance value between the cathode mixture layer and the aluminum current collector is 1 Ω·cm² or less,

LiₓA_{y}D_{z}PO₄ (1)

(here, A represents at least one element selected from the group consisting of Co, Mn, Ni, Fe, Cu, and Cr, D represents at least one element selected from the group consisting of Mg, Ca, Sr, Ba, Ti, Zn, B, Al, Ga, In, Si, Ge, Sc, and Y, 0.9<x<1.1, 0<y≦1, 0≦z<1, and 0.9<y+z<1.1).

<6>The cathode material fora lithium-ion secondary battery according to [5], in which, in a case in which the cathode mixture layer including the cathode material, the conductive auxiliary agent, and the binding agent in a weight ratio (the cathode material/the conductive auxiliary agent/the binding agent) of 90:5:5 is calendered on the 30 μm-thick aluminum current collector at a total applied pressure of 5 t/250 mm, a volume resistance value of the cathode mixture layer is 5 Ω·cm or less.

<7> The cathode material fora lithium-ion secondary battery according to <5> or <6>, in which a particle diameter (D90) at which a cumulative percentage of the cathode material is 90% in a cumulative particle size distribution is 15 μm or less, in a case in which the cathode mixture layer including the cathode material, the conductive auxiliary agent, and the binding agent in a weight ratio (the cathode material/the conductive auxiliary agent/the binding agent) of 90:5:5 is calendered on the 30 μm-thick aluminum current collector at a total applied pressure of 5 t/250 mm, a ratio (the interface resistance value/D90) of the interface resistance value between the cathode mixture layer and the aluminum current collector to the D90 is 0.1 or less, and a ratio (the volume resistance value/D90) of the volume resistance value of the cathode mixture layer to the D90 is 0.10 or more and 0.60 or less.

<8> The cathode material fora lithium-ion secondary battery according to any one of <5>to <7>, in which a specific surface area of the cathode material is 10 m²/g or more and 25 m²/g or less, and an oil absorption amount for which N-methyl-2-pyrrolidone is used is 50 ml/100 g or less.

<9> The cathode material fora lithium-ion secondary battery according to any one of <5> to <8>, in which, in a case in which the cathode mixture layer including the cathode material, the conductive auxiliary agent, and the binding agent in a weight ratio (the cathode material/the conductive auxiliary agent/the binding agent) of 90:5:5 is calendered on the 30 μm-thick aluminum current collector at a total applied pressure of 5 t/250 mm, an electrode density of the cathode mixture layer after calendering is 1.4 g/cm³ or more.

According to the present invention, it is possible to provide a lithium-ion secondary battery having improved charge and discharge characteristics and a cathode material for a lithium-ion secondary battery capable of decreasing the volume resistance value of electrode mixture layers and the interface resistance value between the electrode mixture layers and aluminum current collectors.

### DETAILED DESCRIPTION OF THE INVENTION

An embodiment of a lithium-ion secondary battery of the present invention will be described.

Meanwhile, the present embodiment is a specific description for easier understanding of the gist of the present invention and, unless particularly otherwise described, does not limit the present invention.

### Lithium-Ion Secondary Battery

A lithium-ion secondary battery of the present embodiment has a cathode, an anode, and an electrolyte. The cathode includes an aluminum current collector and a cathode mixture layer formed on the aluminum current collector, and the interface resistance value between the cathode mixture layer and the aluminum current collector is 1 Ω·cm² or less.

Here, the interface resistance value means a resistance value at an interface with which two layers are in contact and, in the present invention, refers to the resistance value at the interface between the cathode mixture layer and the aluminum current collector.

When the interface resistance value between the cathode mixture layer and the aluminum current collector is higher than 1 Ω·cm², there is a concern that electron conductivity may decrease. The interface resistance value between the cathode mixture layer and the aluminum current collector is preferably 0.8 Ω·cm² or less, more preferably 0.5 Ω·cm² or less, and still more preferably 0.1 Ω·cm² or less from the viewpoint of increasing electron conductivity.

Meanwhile, the interface resistance value can be measured using a method described in the examples.

The cathode mixture layer preferably includes the cathode material made of agglomerated particles formed by agglomeration of a plurality of primary particles of the cathode active material represented by General Formula (1) below which are coated with a carbonaceous film from the viewpoint of a high discharge capacity and a high energy density.

LiₓA_{y}D_{z}PO₄ (1)

(Here, A represents at least one element selected from the group consisting of Co, Mn, Ni, Fe, Cu, and Cr, D represents at least one element selected from the group consisting of Mg, Ca, Sr, Ba, Ti, Zn, B, Al, Ga, In, Si, Ge, Sc, and Y, 0.9<x<1.1, 0<y≦1, 0≦z<1, and 0.9<y+z<1.1).

Here, A is preferably Co, Mn, Ni, or Fe, and more preferably Fe.

D is preferably Mg, Ca, Sr, Ba, Ti, Zn, or Al. In a case in which the cathode active material includes these elements, it is possible to produce cathode mixture layers capable of realizing a high discharge potential and favorable safety. In addition, these elements are resources having an abundant amount and are thus preferred as materials to be selected.

The volume resistance value of the cathode mixture layer is preferably 5 Ω·cm or less, more preferably 4.8 Ω·cm or less, and still more preferably 4.5 Ω·cm or less. When the volume resistance value of the cathode mixture layer is 5 Ω·cm or less, it is possible to improve electron conductivity.

Meanwhile, the volume resistance value can be measured using a method described in the examples.

The electrode density of the cathode mixture layer after calendering is preferably 1.4 g/cm³ or more and more preferably 1.5 g/cm³ or more. When the electrode density of the cathode mixture layer after calendering is 1.4 g/cm³ or more, it is possible to improve electron conductivity.

Meanwhile, the electrode density can be measured using a method described in the examples.

The average primary particle diameter of the primary particles of the cathode active material represented by General Formula (1) which are coated with a carbonaceous film (carbonaceous coated electrode active material) is preferably 10 nm or more and 400 nm or less, more preferably 20 nm or more and 300 nm or less, and still more preferably 20 nm or more and 200 nm or less.

When the average primary particle diameter of the primary particles is 10 nm or more, an increase in the amount of necessary carbon due to an increase in the specific surface area of the primary particles of the cathode active material is suppressed, and it is possible to suppress a decrease in the charge and discharge capacity per unit mass of the cathode material. In addition, it becomes easy to uniformly coat the surfaces of the primary particles of the cathode active material with a carbonaceous film. As a result, lithium-ion secondary batteries for which the cathode material fora lithium-ion secondary battery of the present embodiment is used have a discharge capacity that increases during high-speed charge and discharge and are capable of realizing sufficient charge and discharge performance. On the other hand, when the average primary particle diameter of the primary particles is 400 nm or less, it is possible to suppress an increase in the lithium ion diffusion resistance or the electron migration resistance in the primary particles of the cathode active material. As a result, lithium-ion secondary batteries for which the cathode material fora lithium-ion secondary battery of the present embodiment are capable of increasing the discharge capacity during high-speed charge and discharge.

Here, the average primary particle diameter is a number-average particle diameter. The average primary particle diameter of the primary particles can be obtained by randomly selecting 100 primary particles, measuring the long diameters and short diameters of the respective primary particles using a scanning electron microscope (SEM), and obtaining an average value thereof.

The carbonaceous film is a film intended to impart desired electron conductivity to the primary particles.

The thickness of the carbonaceous film is preferably 0.5 nm or more and 5.0 nm or less and more preferably 1.0 nm or more and 3.0 nm or less.

When the thickness of the carbonaceous film is 0.5 nm or more, the thickness of the carbonaceous film becomes too thin, and it is possible to form a film having a desired resistance value. As a result, the conductivity improves, and it is possible to ensure conductivity suitable for cathode materials. On the other hand, when the thickness of the carbonaceous film is 5.0 nm or less, battery activity, for example, the battery capacity of the cathode material per unit mass, decreases.

In addition, the coating ratio of the carbonaceous film to the primary particles is preferably 60% or more and particularly preferably 80% or more. When the coating ratio of the carbonaceous film is 60% or more, the coating effect of the carbonaceous film can be sufficiently obtained.

The amount of carbon included in the primary particles is preferably 0.5% by mass or more and 5.0% by mass or less and more preferably 0.8% by mass or more and 2.5% by mass or less.

When the amount of carbon is 0.5% by mass or more, it is possible to ensure conductivity suitable for cathode materials, the discharge capacity at a high charge-discharge rate increases in a case in which lithium-ion secondary batteries are formed, and it is possible to realize sufficient charge and discharge rate performance. On the other hand, when the amount of carbon is 5.0% by mass or less, the amount of carbon becomes too large, and it is possible to suppress the battery capacity of lithium-ion secondary batteries per unit mass of the cathode material for a lithium-ion secondary battery decreasing more than necessary.

The average secondary particle diameter of the agglomerated particles formed by the agglomeration of a plurality of the primary particles is preferably 0.5 μm or more and 15 μm or less and more preferably 1.0 μm or more and 10 μm or less. When the average secondary particle diameter of the agglomerated particles is 0.5 μm or more, it is possible to suppress the blending amount of a conductive auxiliary agent and a binding agent when cathode material paste for a lithium-ion secondary battery is prepared by mixing the cathode material, the conductive auxiliary agent, and a binder resin (the binding agent) together, and it is possible to increase the battery capacity of lithium-ion secondary batteries per unit mass of the cathode mixture layer for a lithium-ion secondary battery. On the other hand, when the average secondary particle diameter of the agglomerated particles is 15 μm or less, it is possible to enhance the dispersibility and uniformity of the conductive auxiliary agent or the binding agent in the cathode mixture layer. As a result, lithium-ion secondary batteries for which the cathode material for a lithium-ion secondary battery of the present embodiment is used are capable of increasing the discharge capacity during high-speed charge and discharge.

Here, the average secondary particle diameter is a volume-average particle diameter. The average secondary particle diameter of the agglomerated particles can be measured using a laser diffraction and scattering particle size distribution analyzer or the like. In addition, the average secondary particle diameter may be obtained by randomly selecting 100 agglomerated particles, measuring the long diameters and short diameters of the respective agglomerated particles using a scanning electron microscope (SEM), and obtaining an average value thereof.

The agglomerated particles are preferably solid particles since it is possible to make the electrode structure uniform. Here, the solid particle refers to a particle substantially having no space therein and may include unintentionally-formed spaces such as fine pores among the primary particles. When the electrode structure is uniform, not only do the Li ion conductivity and the electron conductivity improve, but the calendering pressure during the production of cathodes is also suppressed, and it is possible to suppress the peeling of the carbonaceous film due to the collapse of the agglomerated particles. In addition, it is possible to prevent the dropping of the electrode mixture layer from the aluminum current collector. In such a case, it is possible to suppress the degradation of battery characteristics.

The particle diameters (D90) at which the cumulative percentage of the cathode material made of the agglomerated particles is 90% in the cumulative particle size distribution is preferably 15 μm or less, more preferably 13 μm or less, and still more preferably 12 μm or less. When D90 is 15 μm or less, the diameters of the agglomerated particles become too large relative to the thickness of the cathode mixture layer, the surface of the cathode mixture layer does not easily become uneven, and the structure of the cathode mixture layer becomes uniform. In addition, the lower limit value of D90 is not particularly limited, but is preferably 3.0 μm or more. In addition, the shape of the agglomerated particle for improving the loading properties of the cathode material into the cathode mixture layer and improving the battery capacity per unit volume is not particularly limited, but is preferably spherical, particularly, truly spherical.

The specific surface area of the cathode material is preferably 10 m²/g or more and 25 m²/g or less, more preferably 10 m²/g or more and 20 m²/g or less, and still more preferably 10 m²/g or more and 15 m²/g or less. When the specific surface area is 10 m²/g or more, the Li ion diffusion resistance or the electron migration resistance in the primary particles of the cathode material for a lithium-ion secondary battery decreases.

Therefore, it is possible to decrease the internal resistance, and the output characteristics can be improved. On the other hand, when the specific surface area is 25 m²/g or less, the specific surface area of the cathode material fora lithium-ion secondary battery does not excessively increase, the mass of necessary carbon is suppressed, and it is possible to improve the battery capacity of lithium-ion secondary batteries per unit mass of the cathode material for a lithium-ion secondary battery.

Meanwhile, the specific surface areas can be measured using a specific surface area meter (for example, manufactured by MicrotracBEL Corp., trade name: BELSORP-mini,) and the BET method.

The oil absorption amount of the cathode material, for which N-methyl-2-pyrrolidone (NMP) is used, is preferably 50 ml/100 g or less, more preferably 45 ml/100 g or less, and still more preferably 40 ml/100 g or less. When the NMP oil absorption amount is 50 ml/100 g or less, during the preparation of the cathode material paste for a lithium-ion secondary battery by mixing the cathode material, the conductive auxiliary agent, and the binder resin (the binding agent) together, the binding agent or a solvent does not easily intrude into the agglomerated particles, an increase in the paste viscosity is suppressed, and it is possible to improve the properties of being applied onto the aluminum current collector. In addition, a necessary amount of the binding agent is obtained, and it is possible to improve the binding properties between the cathode mixture layer and the aluminum current collector.

Meanwhile, the NMP oil absorption amount can be measured using a method described in the examples.

In the present invention, in a case in which the cathode mixture layer including the cathode material, the conductive auxiliary agent, and the binding agent in a weight ratio (the cathode material/the conductive auxiliary agent/the binding agent) of 90:5:5 is calendered on the 30 μm-thick aluminum current collector at a total applied pressure of 5 t/250 mm, the use of the cathode material enables the setting of the interface resistance value between the cathode mixture layer and the aluminum current collector to 1 Ω·cm² or less, preferably 0.8 Ω·cm² or less, more preferably 0.5 Ω·cm² or less, and still more preferably 0.1 Ω·cm² or less and the setting of the volume resistance value of the cathode mixture layer to preferably 5 Ω·cm or less, more preferably 4.8 Ω·cm or less, and still more preferably 4.5 Ω·cm or less. In addition, the electrode density of the cathode mixture layer after calendering can be preferably set to 1.4 g/cm³ or more and more preferably set to 1.5 g/cm³ or more.

Furthermore, under the above-described conditions, the ratio (the interface resistance value/D90) of the interface resistance value between the cathode mixture layer and the aluminum current collector to the D90 can be preferably set to 0.1 or less, more preferably set to 0.08 or less, and still more preferably set to 0.05 or less. In addition, the ratio (the volume resistance value/D90) of the volume resistance value of the cathode mixture layer to the D90 can be preferably set to 0.10 or more and 0.60 or less, more preferably set to 0.11 or more and 0.50 or less, and still more preferably set to 0.12 or more and 0.30 or less.

### Method for Manufacturing Cathode

A method for manufacturing a cathode of the present embodiment is not particularly limited as long as the cathode mixture layer can be formed on one main surface of the aluminum current collector using the cathode material of the present embodiment.

First, a method for manufacturing a cathode material will be described.

### Method for Manufacturing Cathode Material

A method for manufacturing a cathode material of the present embodiment has, for example, a manufacturing step of a cathode active material and a cathode active material precursor, a slurry preparation step of preparing a slurry by mixing at least one cathode active material raw material selected from the group consisting of the cathode active material and the cathode active material precursor and water, a granulation step of obtaining a granulated body by adding an agglomeration-maintaining agent to the slurry obtained in the above-described step, and a calcination step of mixing an organic compound which is a carbonaceous film precursor into the granulated body obtained in the above-described step in a dry manner and calcinating the obtained mixture in a non-oxidative atmosphere.

### Manufacturing Method of Cathode Active Material and Cathode Active Material Precursor

As the manufacturing step of the cathode active material represented by General Formula (1) and the cathode active material precursor, it is possible to use a method of the related art such as a solid phase method, a liquid phase method, or a gas phase method. Examples of LiₓA_{y}D_{z}PO₄ obtained using the above-described method include particulate LiₓA_{y}D_{z}PO₄ (hereinafter, in some cases, referred to as “LiₓA_{y}M_{z}PO₄ particles”).

The LiₓA_{y}D_{z}PO₄ particles can be obtained by, for example, hydrothermally synthesizing a slurry-form mixture obtained by mixing a Li source, an A source, a P source, water, and, as necessary, a D source. By means of the hydrothermal synthesis, LiₓA_{y}D_{z}PO₄ is generated as a precipitate in water. The obtained precipitate maybe a precursor of LiₓA_{y}D_{z}PO₄. In this case, target LiₓA_{y}D_{z}PO₄ particles are obtained by calcinating the precursor of LiₓA_{y}D_{z}PO₄.

In this hydrothermal synthesis, a pressure-resistant airtight container is preferably used.

Here, examples of the Li source include lithium salts such as lithium acetate (LiCH₃COO) and lithium chloride (LiCl), lithium hydroxide (LiOH), and the like. Among these, as the Li source, at least one selected from the group consisting of lithium acetate, lithium chloride, and lithium hydroxide is preferably used.

Examples of the A source include chlorides, carboxylates, hydrosulfates, and the like which include at least one element selected from the group consisting of Co, Mn, Ni, Fe, Cu, and Cr. For example, in a case in which A in LiₓA_{y}D_{z}PO₄ is Fe, examples of the Fe source include divalent iron salts such as iron (II) chloride (FeCl₂), iron (II) acetate (Fe (CH₃COO)₂), and iron (II) sulfate (FeSO₄). Among these, as the Fe source, at least one selected from the group consisting of iron (II) chloride, iron (II) acetate, and iron (II) sulfate is preferably used.

Examples of the D source include chlorides, carboxylates, hydrosulfates, and the like which include at least one element selected from the group consisting of Mg, Ca, Co, Sr, Ba, Ti, Zn, B, Al, Ga, In, Si, Ge, Sc, and Y.

Examples of the P source include phosphoric acid compounds such as phosphoric acid (H₃PO₄), ammonium dihydrogen phosphate (NH₄H₂PO₄), diammonium phosphate ((NH₄)₂HPO₄), and the like. Among these, as the P source, at least one selected from the group consisting of orthophosphonic acid, ammonium dihydrogen phosphate, and diammonium phosphate is preferably used.

### Slurry Preparation Step

In the present step, a cathode active material raw material obtained in the above-described step is dispersed in water, thereby preparing a homogeneous slurry. When the cathode active material raw material is dispersed in water, it is also possible to add a dispersant thereto. A method for dispersing the cathode active material raw material in water is not particularly limited, and it is preferable to use, for example, a medium stirring-type dispersion device that stirs medium particles at a high rate such as a planetary ball mill, an oscillation ball mill, a bead mill, a paint shaker, or an attritor.

During the preparation of the slurry, the ratio (D90/D10) of the particle diameter (D90) at a cumulative percentage of 90% to the particle diameter (D10) at 10% in the cumulative particle size distribution of the cathode active material raw material in the slurry may be controlled to reach 1 or more and 30 or less. When (D90/D10) is set in the above-described range, the particle size distribution of the cathode active material raw material in the slurry becomes broad, the density of agglomerated particles to be obtained increases, and the effects of the present invention can be exhibited. In addition, when (D90/D10) is set in the above-described range, the viscosity of the slurry decreases, and it is possible to suppress the generation of air bubbles and the like in the slurry in the granulation step described below.

Meanwhile, the dispersion conditions of the slurry can be adjusted using, for example, the concentration, stirring rate, stirring time, and the like of the cathode active material raw material in the slurry.

### Granulation Step

In the present step, a granulated body is manufactured from the cathode active material raw material in the slurry. The granulated body is preferably solid particles from the viewpoint of exhibiting the effects of the present invention. In addition, it is preferable to mix a minimum necessary amount of an agglomeration-maintaining agent into the slurry so as to prevent the collapse of the granulated body. Here, the agglomeration-maintaining agent refers to a compound which helps the agglomeration of the primary particles and maintains the shape of the secondary particles formed by the agglomeration of the primary particles.

During the granulation, when the generation of air bubbles and the like in the slurry is suppressed, it becomes easy to obtain solid particles. As a method for suppressing the generation of air bubbles and the like and suppressing the collapse of the granulated body, in the present invention, the agglomeration-maintaining agent is added to the slurry in the granulation step. Specific examples thereof include a method in which an organic acid such as citric acid, polyacrylic acid, or ascorbic acid is added to and mixed with the slurry as the agglomeration-maintaining agent. When the pH of the slurry is decreased using the organic acid, the agglomeration of the primary particles is helped, secondary particles in which the primary particles are more densely packed can be formed after the granulation, and it is possible to increase the strength of the secondary particles.

The reason for selecting the organic acid is that, in the calcination step described below, it is preferable that the agglomeration-maintaining agent does not remain as an impurity in the calcination step described below and is carbonized as part of the carbonaceous film. However, the organic acid does not easily remain as coal, and thus the selection of the organic acid does not always generate the carbonaceous film and, furthermore, it is difficult to form favorable carbonaceous films, and thus the addition of a large amount of the organic acid is not preferable. In addition, a carbonization catalyst may be used in order to accelerate the carbonization of the organic compound in the calcination step described below.

The blending amount of the agglomeration-maintaining agent is preferably 0.1% to 1.0% by mass and more preferably 0.2% to 0.5% by mass of the cathode active material raw material in terms of the solid contents. When the blending amount is set to 0.1% by mass or more, the collapse of the granulated body can be suppressed, and, when the blending amount is 1.0% by mass or less, it is possible to suppress the generation of air bubbles and the like derived from the agglomeration-maintaining agent.

In addition, when the concentration of the cathode active material raw material in the slurry is prepared to be preferably 15% to 55% by mass and more preferably 20% to 50% by mass, it is possible to obtain spherical solid particles.

Next, the mixture obtained above is sprayed and dried in a high-temperature atmosphere in which the atmosphere temperature is the boiling point or higher of the solvent, for example, in the atmosphere at 100° C. to 250° C.

Here, when the conditions during the spraying, for example, the concentration, spraying pressure, and rate of the cathode active material raw material in the slurry, and furthermore, the conditions during the drying after the spraying, for example, the temperature-increase rate, the peak holding temperature, the holding time, and the like are appropriately adjusted, a dried substance having an average secondary particle diameter of the agglomerated particles, which has been described above, in the above-described range can be obtained.

The atmosphere temperature during the spraying and drying have an influence on the evaporation rate of the solvent in the slurry, and the structure of a dried substance to be obtained by means of spraying and drying can be controlled using the atmosphere temperature.

For example, as the atmosphere temperature approximates to the boiling point of the solvent in the slurry, the time taken to dry sprayed liquid droplets extends, and thus the dried substance to be obtained is sufficiently shrunk during the time required for the drying. Therefore, the dried substance sprayed and dried at the atmosphere temperature near the boiling point of the solvent in the slurry is likely to have a solid structure.

### Calcination Step

In the present step, the granulated body obtained in the above-described step is calcinated in a non-oxidative atmosphere.

First, before calcination, an organic compound which is a carbonaceous film precursor is mixed into the granulated body in a dry manner.

The organic compound is not particularly limited as long as the organic compound is capable of forming the carbonaceous film on the surface of the cathode active material, and examples thereof include polyvinyl alcohol (PVA), polyvinyl pyrrolidone, cellulose, starch, gelatin, carboxymethyl cellulose, methyl cellulose, hydroxymethyl cellulose, hydroxyethyl cellulose, polystyrene sulfonate, polyacrylamide, polyvinyl acetate, glucose, fructose, galactose, mannose, maltose, sucrose, lactose, glycogen, pectin, alginic acid, glucomannan, chitin, hyaluronic acid, chondroitin, agarose, polyethers, divalent alcohols, trivalent alcohols, and the like. However, examples thereof do not include those considered as the organic acid that is used in the above-described granulation step. These organic compounds may be used singly or a mixture of two or more organic compounds may be used.

Regarding the blending ratio between the organic compound and the cathode active material raw material, the weight of carbon obtained from the organic compound is preferably 0.5 parts by mass or more and 2.5 parts by mass or less with respect to 100 parts by mass of an active material that is obtained from the cathode active material raw material. The actual blending amount varies depending on the carbonization amount (the kind of the carbon source or the carbonization conditions) bymeans of heating and carbonization, but is approximately 0.7 parts by weight to 6 parts by weight.

Next, the mixture obtained by means of the above-described drying and mixing is calcinated in a non-oxidative atmosphere at a temperature of preferably 650° C. or higher and 1,000° C. or lower and more preferably 700° C. or higher and 900° C. or lower for 0.1 hours or longer and 40 hours or shorter.

The non-oxidative atmosphere is preferably an atmosphere filled with an inert gas such as nitrogen (N₂), argon (Ar), or the like. In a case in which it is necessary to further suppress the oxidation of the mixture, a reducing atmosphere including approximately several percentages by volume of a reducing gas such as hydrogen (H₂) is preferred. In addition, for the purpose of removing organic components evaporated in the non-oxidative atmosphere during calcination, a susceptible or burnable gas such as oxygen (O₂) may be introduced into the non-oxidative atmosphere.

Here, when the calcination temperature is set to 650° C. or higher, it is easy for the organic compound in the mixture to be sufficiently decomposed and reacted, and the organic compound is easily and sufficiently carbonized. As a result, it is easy to prevent the generation of a high-resistance decomposed substance of the organic compound in the obtained agglomerated particles. Meanwhile, when the calcination temperature is set to 1,000° C. or lower, lithium (Li) in the cathode active material raw material is not easily evaporated, and the grain growth of the cathode active material to a size that is equal to or larger than the target size is suppressed. As a result, in a case in which a lithium-ion secondary battery including a cathode including the cathode material of the present embodiment is produced, it is possible to prevent the discharge capacity at a high charge-discharge rate from decreasing, and it is possible to realize lithium-ion secondary batteries having sufficient charge and discharge rate performance.

By means of the above-described steps, the organic compound in the mixture is carbonized, the primary particles that cover the surface of the cathode active material with the carbonaceous film derived from the organic compound are generated, and a plurality of the primary particles agglomerate together so as to become agglomerated particles.

### Preparation of Cathode Material Paste

As a method for manufacturing a cathode of the present embodiment, for example, a cathode material including the cathode active material of the present embodiment, a binding agent made of a binder resin, and a solvent are mixed together, thereby preparing cathode material paste. To the cathode material paste in the present embodiment, a conductive auxiliary agent such as carbon black or inorganic phosphate particles may be added thereto as necessary.

Binding agent for preparing cathode material paste

As the binding agent, that is, the binder resin, for example, a polytetrafluoroethylene (PTFE) resin, a polyvinylidene fluoride (PVdF) resin, fluorine rubber, or the like is preferably used.

The blending amount of the binding agent used to prepare the cathode material paste is not particularly limited and is, for example, preferably 1 part by mass or more and 30 parts by mass or less and more preferably 3 parts by mass or more and 20 parts by mass or less with respect to 100 parts by mass of the cathode material for a lithium-ion secondary battery.

When the blending amount of the binding agent is 1 part by mass or more, it is possible to sufficiently increase the binding property between the cathode mixture layer and the aluminum current collector. Therefore, it is possible to prevent the cathode mixture layer from being cracked or dropped during the formation of the cathode mixture layer by means of rolling or the like. In addition, it is possible to prevent the cathode mixture layer from being peeled off from the aluminum current collector in the charge and discharge process of lithium-ion secondary batteries and prevent the battery capacity or the charge-discharge rate from being decreased. On the other hand, when the blending amount of the binding agent is 30 parts by mass or less, the internal resistance of the cathode material for a lithium-ion secondary battery decreases, and it is possible to prevent the battery capacity at a high charge-discharge rate from being decreased.

### Conductive Auxiliary Agent

The conductive auxiliary agent is not particularly limited, and, for example, at least one element selected from the group consisting of fibrous carbon such as acetylene black (AB), KETJEN BLACK, furnace black, vapor-grown carbon fiber (VGCF), and carbon nanotube is used.

### Solvent for Preparing Cathode Material Paste

The solvent that is used in the cathode material paste including the cathode active material of the present embodiment is appropriately selected depending on the properties of the binding agent. When the solvent is appropriately selected, it is possible to facilitate the application of the cathode material paste to substances to be coated such as current collectors.

Examples of the solvent include water; alcohols such as methanol, ethanol, 1-propanol, 2-propanol (isopropyl alcohol: IPA), butanol, pentanol, hexanol, octanol, and diacetone alcohol; esters such as ethyl acetate, butyl acetate, ethyl lactate, propylene glycol monomethyl ether acetate, propylene glycol monoethyl ether acetate, and γ-butyrolactone; ethers such as diethyl ether, ethylene glycol monomethyl ether (methyl cellosolve), ethylene glycolmonoethyl ether (ethyl cellosolve), ethylene glycol monobutyl ether (butyl cellosolve), diethylene glycol monomethyl ether, and diethylene glycol monoethyl ether; ketones such as acetone, methyl ethyl ketone (MEK), methyl isobutyl ketone (MIBK), acetylacetone, and cyclohexanone; amides such as dimethyl formamide, N,N-dimethylacetoacetamide, and N-methyl-2-pyrrolidone (NMP); glycols such as ethylene glycol, diethylene glycol, and propylene glycol, and the like. These solvents may be used singly, or a mixture of two or more solvents may be used.

The content rate of the solvent in the cathode material paste is preferably 50% by mass or more and 70% by mass or less and more preferably 55% by mass or more and 65% by mass or less in a case in which the total mass of the cathode active material of the present embodiment, the binding agent, and the solvent is set to 100% by mass.

When the content rate of the solvent in the cathode material paste is in the above-described range, it is possible to obtain cathode material paste having excellent cathode formability and excellent battery characteristics.

A method for mixing the cathode material including the cathode active material of the present embodiment, the binding agent, the conductive auxiliary agent, and the solvent is not particularly limited as long as these components can be uniformly mixed together. Examples thereof include mixing methods in which a kneader such as a ball mill, a sand mill, a planetary (sun-and-planet) mixer, a paint shaker, or a homogenizer is used.

The cathode material paste is applied to one main surface of the aluminum current collector so as to form a coated film, and then this coated film is dried, thereby obtaining an aluminum current collector having a coated film made of a mixture of the cathode material and the binding agent formed on one main surface.

After that, the coated film is pressed by pressure and is dried, thereby producing a cathode having the cathode mixture layer on one main surface of the aluminum current collector.

### Anode

Examples of the anode include anodes including a carbon material such as metallic Li, natural graphite, or hard carbon or an anode material such as a Li alloy, Li₄Ti₅O₁₂, or Si (Li_{4.4}Si).

### Electrolyte

The electrolyte is not particularly limited, but is preferably a non-aqueous electrolyte, and examples thereof include electrolytes obtained by mixing ethylene carbonate (EC) and ethyl methyl carbonate (EMC) so that the volume ratio reaches 1:1 and dissolving lithium hexafluorophosphate (LiPF₆) in the obtained solvent mixture so that the concentration reaches 1 mol/dm³.

### Separator

The cathode of the present embodiment and the anode of the present embodiment can be made to face each other through a separator. As the separator, it is possible to use, for example, porous propylene.

In addition, instead of the non-aqueous electrolyte and the separator, a solid electrolyte may be used.

Since the lithium-ion secondary battery of the present embodiment includes the cathode for a lithium-ion secondary battery of the present embodiment as the cathode, it is possible to decrease the volume resistance value of the electrode mixture layer and the interface resistance value between the electrode mixture layer and the aluminum current collector, and the charge and discharge characteristics can be improved.

### EXAMPLES

Hereinafter, the present invention will be specifically described using examples and comparative examples. Meanwhile, the present invention is not limited to forms described in the examples.

### Synthesis of Cathode Material for Lithium-Ion Secondary Battery

### Example 1

Lithium phosphate (Li₃PO₄) as a Li source and a P source and iron (II) sulfate (FeSO₄) as a Fe source were mixed together so that the molar ratio (Li:Fe:P) reached 3:1:1. Furthermore, distilled water for preparation was mixed thereinto, thereby preparing a raw material slurry (600 ml).

Next, this raw material slurry was stored in a pressure-resistant airtight container, was hydrothermally synthesized at 180° C. for two hours, and was cooled to room temperature (25° C.), thereby obtaining cake-form cathode active material particles which were precipitated in the container. The cathode active material particles were sufficiently cleaned a plurality of times with distilled water, and then the cathode active material particles and the distilled water were mixed together so that the concentration of the cathode active material particles reached 60% by mass, thereby preparing a suspended slurry.

The suspended slurry was injected into a sand mill together with zirconia balls having a diameter of 0.1 mm, and a dispersion treatment was carried out with the treatment time of the sand mill adjusted so that the ratio (D90/D10) of the particle diameter (D90) at a cumulative percentage of 90% to the particle diameter (D10) at a cumulative percentage of 10% in the cumulative particle size distribution of the cathode active material particles in the suspended slurry reached two.

Next, an aqueous solution of citric acid which had been adjusted to 30% by mass, which amounted to 1.0% by mass of the cathode active material particles in terms of the solid content of the citric acid, was mixed into the slurry on which the dispersion treatment had been carried out, furthermore, distilled water was mixed therewith so that the concentration of the cathode active material particles in the slurry reached 50% by mass, and then the mixture was sprayed and dried in the atmosphere at 180° C., thereby obtaining a granulated dried substance of the cathode active material particles.

Next, polyvinyl alcohol powder, which amounted to 3.5% by mass of the cathode active material particles, was mixed into the obtained dried substance in a dry manner, and a thermal treatment was carried out at 750° C. in an inert atmosphere for one hour so as to support carbon in the cathode active material particles, thereby producing a cathode material fora lithium-ion secondary battery of Example 1.

### Example 2

A cathode material for a lithium-ion secondary battery of Example 2 was produced in the same manner as in Example 1 except for the fact that an aqueous solution of citric acid which had been adjusted to 30% by mass in advance, which amounted to 1.0% by mass of the cathode active material particles in terms of the solid content of the citric acid, was mixed into the slurry on which the dispersion treatment had been carried out using a sand mill, and furthermore, distilled water was mixed therewith so that the concentration of the cathode active material particles in the slurry reached 25% by mass.

### Example 3

A cathode material for a lithium-ion secondary battery of Example 3 was produced in the same manner as in Example 1 except for the fact that a suspended slurry adjusted so that the concentration of the cathode active material particles reached 60% by mass was injected into a sand mill together with zirconia balls having a diameter of 1 mm, and a dispersion treatment was carried out with the treatment time of a ball mill adjusted so that the ratio (D90/D10) reached 25 in the cathode active material particles in the suspended slurry.

### Example 4

A cathode material for a lithium-ion secondary battery of Example 4 was produced in the same manner as in Example 3 except for the fact that an aqueous solution of citric acid which had been adjusted to 30% by mass in advance, which amounted to 1.0% by mass of the cathode active material particles in terms of the solid content of the citric acid, was mixed into the slurry on which the dispersion treatment had been carried out using a sand mill, and furthermore, distilled water was mixed therewith so that the concentration of the cathode active material particles in the slurry reached 25% by mass.

### Example 5

An aqueous solution of citric acid which had been adjusted to 30% by mass in advance, which amounted to 1.0% by mass of the cathode active material particles in terms of the solid content of the citric acid, was mixed into the slurry on which the dispersion treatment had been carried out using a sand mill, furthermore, distilled water was mixed therewith so that the concentration of the cathode active material particles in the slurry reached 50% by mass, and then the mixture was sprayed and dried in the atmosphere at 180° C., thereby obtaining a granulated dried substance of the cathode active material particles.

Next, glucose powder, which amounted to 4.7% by mass of the cathode active material particles, was mixed into the obtained dried substance in a dry manner. Except for the above-described facts, a cathode material for a lithium-ion secondary battery of Example 5 was produced in the same manner as in Example 1.

### Example 6

A cathode material for a lithium-ion secondary battery of Example 6 was produced in the same manner as in Example 5 except for the fact that an aqueous solution of citric acid which had been adjusted to 30% by mass in advance, which amounted to 1.0% by mass of the cathode active material particles in terms of the solid content of the citric acid, was mixed into the slurry on which the dispersion treatment had been carried out using a sand mill, and furthermore, distilled water was mixed therewith so that the concentration of the cathode active material particles in the slurry reached 25% by mass.

### Comparative Example 1

A cathode material for a lithium-ion secondary battery of Comparative Example 1 was produced in the same manner as in Example 1 except for the fact that an aqueous solution of polyvinyl alcohol which had been adjusted to 15% by mass in advance, which amounted to 3.5% by mass of the cathode active material particles in terms of the solid content of the polyvinyl alcohol, was mixed into the slurry on which the dispersion treatment had been carried out using a sand mill, distilled water was mixed therewith so that the concentration of the cathode active material particles in the slurry reached 50% by mass, and then the mixture was sprayed and dried in the atmosphere at 180° C.

### Comparative Example 2

A cathode material for a lithium-ion secondary battery of Comparative Example 2 was produced in the same manner as in Comparative Example 1 except for the fact that an aqueous solution of polyvinyl alcohol which had been adjusted to 15% by mass in advance, which amounted to 3.5% by mass of the cathode active material particles in terms of the solid content of the polyvinyl alcohol, was mixed into the slurry on which the dispersion treatment had been carried out using a sand mill, and distilled water was mixed therewith so that the concentration of the cathode active material particles in the slurry reached 25% by mass.

### Comparative Example 3

Cake-form cathode active material particles obtained by means of hydrothermal synthesis were cleaned sufficiently a plurality of times with distilled water, and then the cathode active material particles and the distilled water were mixed together so that the concentration of the cathode active material particles reached 60% by mass, thereby preparing a suspended slurry. Next, a cathode material for a lithium-ion secondary battery of Comparative Example 3 was produced in the same manner as in Example 1 except for the fact that the dispersion treatment was not carried out on the suspended slurry and the aqueous solution of citric acid was not mixed therewith.

### Comparative Example 4

Cake-form cathode active material particles obtained by means of hydrothermal synthesis were cleaned sufficiently a plurality of times with distilled water, and then the cathode active material particles and the distilled water were mixed together so that the concentration of the cathode active material particles reached 60% by mass, thereby preparing a suspended slurry. Next, a cathode material for a lithium-ion secondary battery of Comparative Example 4 was produced in the same manner as in Example 6 except for the fact that the dispersion treatment was not carried out on the suspended slurry and the aqueous solution of citric acid was not mixed therewith.

### Evaluation of Cathode Materials

The obtained cathode materials were evaluated using the following methods. The results are shown in Table 1.

### 1. Particle Diameter (D90) at Cumulative Percentage of 90% in Cumulative Particle Size Distribution

The particle diameters were measured using a laser diffraction particle size distribution analyzer (manufactured by Horiba Ltd., trade name: LA-950V2).

### 2. Specific Surface Area

The specific surface areas of the cathode materials were measured using a specific surface area meter (manufactured by MicrotracBEL Corp., trade name: BELSORP-mini,) and a BET method in which nitrogen (N₂) adsorption was used.

### 3. Oil Absorption Amount for Which N-methyl-2-Pyrrolidone (NMP) was Used (NMP Oil Absorption Amount)

The oil absorption amount for which N-methyl-2-pyrrolidone (NMP) was used was measured using a method according to JIS K5101-13-1 (refined linseed oil method) and linseed oil instead of NMP.

### Production of Cathodes

The obtained cathode material, polyvinylidene fluoride (PVdF) as a binding agent, and acetylene black (AB) as a conductive auxiliary agent were mixed together so that the mass ratio therebetween reached 90:5:5, and furthermore, N-methyl-2-pyrrolidone (NMP) was added thereto as a solvent so as to impart fluidity, thereby producing a slurry.

Next, this slurry was applied and dried on a 30 μm-thick aluminum (Al) foil (current collector). After that, the product was cut into a strip shape having an application width of 40 mm and was pressed at a total applied pressure of 5 t/250 mm using a roll calendaring machine, thereby producing a cathode of each of the examples and the comparative examples.

### Evaluation of Cathodes

The obtained cathodes were evaluated using the following method. The results are shown in Table 1.

### 4. Electrode Density After Calendering

The cathode pressed at a total applied pressure of 5 t/250 mm was punched into φ15.9 mm using a coin-type clicking machine.

The thickness of the punched cathode was measured at five points, a value obtained by subtracting the thickness of the current collector from the average value thereof was considered as the thickness of the cathode, and the cathode volume was computed. Similarly, the mass of the cathode was computed from the difference in mass between the electrode and the current collector and was divided by the cathode volume, thereby obtaining an electrode density after calendering.

### 5. Interface Resistance Value Between Cathode Mixture Layer and Aluminum Current Collector

The interface resistance value was measured using an electrode resistance measurement instrument (manufactured by Hioki E. E. Corporation, trade name: XF057-012) under conditions of an applied current value of 1 mA, a voltage range of 0.2 V, and a normal measurement speed. Meanwhile, the voltage range was arbitrarily adjusted in a range in which the resistance value was not overloaded.

### 6. Volume Resistance Value of Cathode Mixture Layer

The volume resistance value was measured using an electrode resistance measurement instrument (manufactured by Hioki E.E. Corporation, trade name: XF057-012) under conditions of an applied current value of 1 mA, a voltage range of 0.2 V, and a normal measurement speed. Meanwhile, the voltage range was arbitrarily adjusted in a range in which the resistance value was not overloaded.

### 7. Interface Resistance Value/D90 and Volume Resistance Value/D90

The ratio (the interface resistance value/D90) was obtained from the interface resistance value obtained in (5) and D90 obtained in (1). In addition, the ratio (the volume resistance value/D90) was obtained from the volume resistance value obtained in (6) and D90.

### Production of Lithium-Ion Secondary Batteries

The cathode for a lithium-ion secondary battery which had been obtained above and a commercially available anode made of natural graphite were punched into a predetermined size, current-collecting tabs were welded to the cathode and the anode respectively, and the cathode and the anode were disposed in an aluminum laminate film through a separator made of a porous polypropylene film. An electrolyte including LiPF₆ having a concentration of 1 mol/dm³ and having EC:DEC=50:50 (vol %) was injected into the aluminum laminate film and was sealed, thereby producing a lithium-ion secondary battery for battery characteristic evaluation.

### Evaluation of Lithium-Ion Secondary Batteries

The obtained lithium-ion secondary batteries were evaluated using the following methods. The results are shown in Table 1.

### 8. Initial Discharge Capacity

A charge and discharge test of the lithium-ion secondary battery was repeatedly carried out three times at room temperature (25° C.) under a constant current at a cut-off voltage of 2.5 V to 3.7 V and a charge and discharge rate of 0.1 C (10-hour charge and then 10-hour discharge), and the discharge capacity at the third cycle was considered as the initial discharge capacity.

### 9. Load Characteristics (Discharge Capacity Ratio)

After the initial discharge capacity was measured, as a charge and discharge test of the lithium-ion secondary battery, at room temperature (25° C.), the lithium-ion secondary battery was charged at a cut-off voltage of 2.5 V to 3.7 V and 0.2 C (five-hour charge), was discharged at 3 C (20-minute discharge), and the discharge capacity was measured.

The ratio between the 3 C discharge capacity and the 0.1 C discharge capacity (the initial discharge capacity) was considered as the load characteristics, and the load characteristics (the discharge capacity ratio) were computed using the following equation (1).

Discharge capacity ratio (%)=(3 C discharge capacity/0.1 C discharge capacity)×100 (1)

### 10. Direct Current Resistance (DCR)

The direct current resistance was measured using a lithium-ion secondary battery in which the depth of charge with a constant current at a charge rate of 0.1 C at an ambient temperature of 0° C. was adjusted to 50% (SOC 50%). In the lithium-ion secondary battery adjusted to SOC 50% at room temperature (25° C.), currents were made to flow on the charge side and the discharge side alternatively at 1 C, 3 C, 5 C, and 10 C rates for ten seconds each, the current values and the voltage values after 10 seconds at the respective rates were plotted in the horizontal axis and the vertical axis respectively, and the slopes of the approximate value line obtained using the least square method on the charge side and on the discharge side were considered as “input DCR” and “output DCR” respectively. Meanwhile, at the respective currents, a 10-minute quiescent time was provided whenever the current flow direction or the flowing current was changed.

TABLE 1

| | | | | | | | | | | Load | Direct | |
|---|---|---|---|---|---|---|---|---|---|---|---|---|
| | | | | Electrode | | | | | | characteristics | current | |
| | | Specific | NMP oil | density | Interface | Volume | | | Initial | (discharge | resistance | |
| | | surface | absorption | after | resistance | resistance | Interface | Volume | discharge | capacity | Input | Output |
| | D90 | area | amount | calendering | value | value | resistance | resistance | capacity | ratio) | DCR | DCR |
| | [μm] | [m²/g] | [mL/100 g] | [g/cm³] | [Ω · cm²] | [Ω · cm] | value/D90 | value/D90 | [mAh/g] | [%] | [Ω] | [Ω] |
| Example 1 | 12.7 | 12.2 | 40 | 1.57 | 0.50 | 3.2 | 0.039 | 0.252 | 138 | 96.8 | 3.1 | 2.7 |
| Example 2 | 9.9 | 12.3 | 35 | 1.60 | 0.10 | 1.6 | 0.010 | 0.162 | 140 | 97.1 | 2.6 | 2.6 |
| Example 3 | 14.8 | 10.2 | 44 | 1.51 | 0.70 | 4.4 | 0.047 | 0.297 | 135 | 93.9 | 3.2 | 2.8 |
| Example 4 | 8.7 | 10.9 | 33 | 1.53 | 0.05 | 1.2 | 0.006 | 0.138 | 137 | 96.6 | 3.1 | 2.8 |
| Example 5 | 8.2 | 13.2 | 39 | 1.60 | 0.09 | 1.4 | 0.011 | 0.171 | 138 | 97.4 | 2.8 | 2.7 |
| Example 6 | 8.2 | 15.0 | 29 | 1.66 | 0.04 | 1.0 | 0.005 | 0.122 | 140 | 96.8 | 2.6 | 2.5 |
| Compar- | 23.4 | 11.6 | 72 | 1.16 | 3.50 | 8.5 | 0.150 | 0.363 | 126 | 80.3 | 6.2 | 3.4 |
| ative | | | | | | | | | | | | |
| Example 1 | | | | | | | | | | | | |
| Compar- | 19.2 | 11.6 | 65 | 1.21 | 2.70 | 7.5 | 0.141 | 0.391 | 126 | 80.7 | 4.7 | 3.4 |
| ative | | | | | | | | | | | | |
| Example 2 | | | | | | | | | | | | |
| Compar- | 19.1 | 7.8 | 64 | 1.20 | 2.10 | 7.5 | 0.110 | 0.393 | 123 | 75.7 | 7.6 | 4.2 |
| ative | | | | | | | | | | | | |
| Example 3 | | | | | | | | | | | | |
| Compar- | 17.7 | 8.9 | 57 | 1.29 | 1.60 | 6.2 | 0.090 | 0.350 | 125 | 77.2 | 6.2 | 4.5 |
| ative | | | | | | | | | | | | |
| Example 4 | | | | | | | | | | | | |

### SUMMARY OF RESULTS

When Examples 1 to 6 and Comparative Examples 1 to 4 were compared with each other using the results of Table 1, it could be confirmed that the cathodes fora lithium-ion secondary battery of Examples 1 to 6 had a low interface resistance value between the cathode mixture layer and the aluminum current collector and a low volume resistance value of the cathode mixture layer. In addition, it could be confirmed that the lithium-ion secondary batteries of Examples 1 to 6 had a low direct current resistance, an excellent initial discharge capacity, and excellent load characteristics.

1. A lithium-ion secondary battery comprising:
a cathode;
an anode; and
an electrolyte,
wherein the cathode includes an aluminum current collector and a cathode mixture layer formed on the aluminum current collector,
wherein the cathode mixture layer including the cathode material, the conductive auxiliary agent, and the binding agent,
wherein an oil absorption amount of the cathode material, for which N-methyl-2-pyrrolidone (NMP) is used, is 50 ml/100 g or less,
wherein a particle diameters (D90) at which the cumulative percentage of the cathode material is 90% in the cumulative particle size distribution is 15 μm or less, and an interface resistance value between the cathode mixture layer and the aluminum current collector is 1 Ω·cm² or less.

2. The lithium-ion secondary battery according to claim 1,
wherein a volume resistance value of the cathode mixture layer is 5 Ω·cm or less.

3. The lithium-ion secondary battery according to claim 1,
wherein an electrode density of the cathode mixture layer after calendering is 1.4 g/cm³ or more.

4. The lithium-ion secondary battery according to claim 1,
wherein the cathode mixture layer includes a cathode material made of agglomerated particles formed by agglomeration of a plurality of primary particles of a cathode active material represented by General Formula (1) below which are coated with a carbonaceous film,
LiₓA_{y}D_{z}PO₄ (1)
(here, A represents at least one element selected from the group consisting of Co, Mn, Ni, Fe, Cu, and Cr, D represents at least one element selected from the group consisting of Mg, Ca, Sr, Ba, Ti, Zn, B, Al, Ga, In, Si, Ge, Sc, and Y, 0.9<x<1.1, O≦z<1, and 0.9<y+z<1.1).

5. A cathode material for a lithium-ion secondary battery made of agglomerated particles formed by agglomeration of a plurality of primary particles of a cathode active material represented by General Formula (1) below which are coated with a carbonaceous film, and an oil absorption amount for which N-methyl-2-pyrrolidone (NMP) is used, is 50 ml/100 g or less,
wherein a particle diameters (D90) at which the cumulative percentage of the cathode material is 90% in the cumulative particle size distribution is 15 μm or less,
wherein, in a case in which a cathode mixture layer of an application width of 40 mm including the cathode material, a conductive auxiliary agent, and a binding agent in a weight ratio (the cathode material/the conductive auxiliary agent/the binding agent) of 90:5:5 is calendered on a 30 μm-thick aluminum current collector at a total applied pressure of 5 t/250 mm,
an interface resistance value between the cathode mixture layer and the aluminum current collector is 1 Ω·cm² or less,
LiₓA_{y}D_{z}PO₄ (1)
(here, A represents at least one element selected from the group consisting of Co, Mn, Ni, Fe, Cu, and Cr, D represents at least one element selected from the group consisting of Mg, Ca, Sr, Ba, Ti, Zn, B, Al, Ga, In, Si, Ge, Sc, and Y, 0.9<x<1.1, 0<y≦1, and 0.9<y+z<1.1).

6. The cathode material for a lithium-ion secondary battery according to claim 5,
wherein, in a case in which the cathode mixture layer of an application width of 40 mm including the cathode material, the conductive auxiliary agent, and the binding agent in a weight ratio (the cathode material/the conductive auxiliary agent/the binding agent) of 90:5:5 is calendered on the 30 μm-thick aluminum current collector at a total applied pressure of 5 t/250 mm,
a volume resistance value of the cathode mixture layer is 5 Ω·cm or less.

7. The cathode material for a lithium-ion secondary battery according to claim 5,
wherein a particle diameter (D90) at which a cumulative percentage of the cathode material is 90% in a cumulative particle size distribution is 15 μm or less, and
in a case in which the cathode mixture layer of an application width of 40 mm including the cathode material, the conductive auxiliary agent, and the binding agent in a weight ratio (the cathode material/the conductive auxiliary agent/the binding agent) of 90:5:5 is calendered on the 30 μm-thick aluminum current collector at a total applied pressure of 5 t/250 mm,
a ratio (the interface resistance value/D90) of the interface resistance value between the cathode mixture layer and the aluminum current collector to the D90 is 0.1 or less, and a ratio (the volume resistance value/D90) of the volume resistance value of the cathode mixture layer to the D90 is 0.10 or more and 0.60 or less.

8. The cathode material for a lithium-ion secondary battery according to claim 5,
wherein a specific surface area of the cathode material is 10 m²/g or more and 25 m²/g or less, and an oil absorption amount for which N-methyl-2-pyrrolidone is used is 50 ml/100 g or less.

9. The cathode material for a lithium-ion secondary battery according to claim 5,
wherein, in a case in which the cathode mixture layer of an application width of 40 mm including the cathode material, the conductive auxiliary agent, and the binding agent in a weight ratio (the cathode material/the conductive auxiliary agent/the binding agent) of 90:5:5 is calendered on the 30 μm-thick aluminum current collector at a total applied pressure of 5 t/250 mm,
an electrode density of the cathode mixture layer after calendering is 1.4 g/cm³ or more.
